(19) United States
(12) Patent Application Publication
(10) Pub. No.: US 2008/0132383 A1
(43) Pub. Date: Jun. 5, 2008

(54) Device And Method For Training, Rehabilitation And/Or Support

(75) Inventors: Omer Einav, Emek Hefer (IL); Haim Einav, Tel-Aviv (IL); Richard M. Mahoney, Westmont, NJ (US)

Correspondence Address: Martin D. Moynihan;PRTSI, P.O.Box 16446, Arlington, VA, 22215, US

(73) Assignee: Tylerton International Inc., Tortola (VG)

(21) Appl. No.: 11/792,477

(22) PCT Filed: Dec. 7, 2005
(86) PCT No.: PCT/IL05/01318

§ 371 Date: Jun. 7, 2007

Related U.S. Application Data
(60) Provisional application No. 60/633,428, filed on Dec. 7, 2004.
(60) Provisional application No. 60/633,442, filed on Dec. 7, 2004.
(60) Provisional application No. 60/665,886, filed on Mar. 28, 2005.
(60) Provisional application No. 60/735,447, filed on Nov. 10, 2005.

(30) Foreign Application Priority Data
Feb. 4, 2005 (IL) PCT/IL2005/000136
Feb. 4, 2005 (IL) PCT/IL2005/000138
Feb. 4, 2005 (IL) PCT/IL2005/000142

(51) Int. Cl. A61H 1/00

(52) U.S. Cl. 482/8

(57) ABSTRACT

A wellness apparatus, comprising: at least one support for a body portion of a user of the apparatus; at least one robotic actuator adapted to move the body portion; and a controller configured to control the actuator in accordance with needs of the user for physical exercise, the controller also adapted for assisting the user with primarily non-physical exercise activity.

### RELATED APPLICATIONS

This application is a continuation-in-part of the following applications all filed on Feb. 4, 2005: PCT/IL2005/000136 entitled “Methods and Apparatuses for Rehabilitation Exercise and Training”; PCT/IL2005/000138 entitled “Gait Rehabilitation Methods and Apparatuses”; and PCT/IL2005/000142 entitled “Methods and Apparatus for Rehabilitation and Training”, the disclosures of which are incorporated herein by reference.

This application also claims the benefit under 119(e) of US Provisional Application No. 60/633,428, filed Dec. 7, 2004, entitled “Gait Rehabilitation Methods and Apparatuses”, U.S. Provisional Application No. 60/633,442, filed Dec. 7, 2004, entitled “Methods and Apparatus for Rehabilitation and Training”, U.S. Provisional Application No. 60/665,886, filed Mar. 28, 2005, entitled “Device and Method for Training, Rehabilitation and/or Support”, and U.S. Provisional Application No. 60/735,447, filed Nov. 10, 2005, entitled “Device and Method for Training, Rehabilitation and/or Support”. The disclosures of all these applications are incorporated herein by reference.

### FIELD OF THE INVENTION

The present invention relates to the field of wellness, for example for older, disabled and obese populations.

### BACKGROUND OF THE INVENTION

Elderly, disabled and obese people are often inactive, due, for example, to physical disability, tiredness, cognitive disability and/or lack of suitable care. One result of this inactivity is further deterioration of various body systems and mental abilities. However, due to the increasing ratio of elderly in the population, it does not appear that sufficient human aids will be available for maintaining wellness of elders.

It is known to use rehabilitation devices and weight lifting systems for the elderly and for rehabilitation of disabled populations in general.

### SUMMARY OF THE INVENTION

An aspect of some embodiments of the invention relates to a wellness system configured to improve wellness of persons. In an exemplary embodiment of the invention, the wellness system includes both physical therapy and integration with daily life in a way that encourages a better life-style. For example, the system can enhance physical, cognitive and/or social activities. In an exemplary embodiment of the invention, the system comprises a chair including at least one actuator for changing one or more of a position of the chair, a part of the chair or an appendage of the chair in a motorized manner and a controller which controls such movement.

An aspect of some embodiments of the invention relates to robotic assisted exercise of the elderly. Possibly, the use of robots allows a better safety level to be achieved with the elderly. Possibly, the use of robots allows an exercise session to be spread out over a long period of time, without need for excessive supervision. Possibly, the use of robots allows better account to be taken of particular and/or time dependent changes in patient ability. Optionally, obese patients are also provided with assistance and exercise safety. Optionally disabled patients are also provided with assistance and exercise safety.

In an exemplary embodiment of the invention, exercising takes place in a chair. Optionally, the chair is specially adapted for an obese patient. For example, the chair and/or chair base is reinforced to accommodate the additional weights expected from an obese patient. Optionally, the chair is sized wider and/or larger than is typically required in order to accommodate an obese patient.

An aspect of some embodiments of the invention relates to a seating system configured to serve as a center of a life of a limited mobility person. In an exemplary embodiment of the invention, the chair performs one or more of: supporting exercise, providing scheduling support, assisting with social interaction and/or assisting in controlling household devices. In an exemplary embodiment of the invention, the seating system is configured to comply with typical daily life styles, supporting, for example, sleep and eating.

In an exemplary embodiment of the invention, the seating system is configured to provide support to a wide range of capabilities, for example, starting from active elderly down to senile and motion-restricted elderly. Optionally, the system also supports rehabilitation and/or monitoring for various conditions all through the life of a patient.

An aspect of some embodiments of the invention, relates to a physical manipulation system comprises at least one arcate element having a diameter on the order of a human arm length. At least one grip/handle is mounted on the arcate element in a non-fixed location. In an exemplary embodiment of the invention, motion of a person's upper limb is supported and/or caused by rotation of the arcate element and/or motion of the grip. Optionally, the grip can telescope relative to the arcate element. Two arcate elements may be provided. Optionally, foot movement elements, for example pedals, are provided.

There is thus provided in accordance with an exemplary embodiment of the invention, a wellness apparatus, comprising: at least one support for a body portion of a user of the apparatus; at least one robotic actuator adapted to move the body portion; and a controller configured to control the actuator in accordance with needs of the user for physical exercise, the controller also adapted for assisting the user with primarily non-physical exercise activity. Optionally, the wellness apparatus further comprises at least one sensor. Optionally, the at least one sensor senses a condition of the apparatus. Optionally, the at least one sensor senses a condition of the user. Optionally, the body portion of a user is at least a portion of an arm, a leg, a head, a thorax, an upper body or a lower body of the user. Optionally, the at least one support is adjustable. Optionally, the at least one support is articulated. In some exemplary embodiments of the invention, the wellness apparatus further comprises at least one wheel or a track adapted to provide mobility of the apparatus. Optionally, the non-physical exercise activity includes a cognitive exercise. Optionally, the wellness apparatus further comprises at least one stimulator adapted and constructed to stimulate at least a portion of the user. In some exemplary embodiments of the invention, the wellness apparatus further comprises a base. Optionally, a position of the apparatus is variably adjustable over a range between a user-standing position and a user-lying down position, including a user-sitting position. Optionally, the wellness apparatus further comprises a receptacle for user generated substances. Optionally, the physical and non-physical exercise is matched to the sensed condition of the user. Optionally, the non-physical exercise activity is at least one of socializing, scheduling support, typical daily activities and controlling other devices. Optionally, the typical daily activities include at least one of sleeping, eating, assuming various positions, exercise or moving around. Optionally, the scheduling support includes at least one of waking up the user, providing reminders, or providing timely medication. Optionally, the socializing includes at least one of communicating with others or participating in activities with others. Optionally, controlling other devices includes controlling at least one of an entertainment device, a household device, a communication device, a door or an alarm. In some exemplary embodiments of the invention, the apparatus is adapted and constructed to accommodate an obese user. Additionally or alternatively, the apparatus is linked to a second wellness apparatus operating in parallel. Optionally, the wellness apparatus further comprises a communication link between the apparatus and a remote monitoring location.

There is thus provided in some exemplary embodiments of the invention, an exercise device, comprising: a base; an arcate element rotatably mounted on the base and having a radius of at least 60 cm; and at least one handle attached to and adapted to move along the arcate element.

There is thus provided in some exemplary embodiments of the invention, a method for managing a user of a wellness device, comprising: sensing by at least the wellness device a condition of the user; matching automatically an activity of the user to the sensed condition, prior to commencing the activity; and, wherein the activity is performed while using the wellness device. Optionally, the wellness device provides a range of scheduling support activities to the user. In some exemplary embodiments of the invention, the method for managing a user of a wellness device further comprises testing the user to evaluate the condition of the user for matching activity. Optionally, testing comprises a verbal portion. Optionally, testing comprises a physical portion. Optionally, testing results in a scoring of the user based on a test performance the user. Optionally, sensing a condition includes checking for activities performed by the user. Optionally, the sensing a condition includes determining a motivation level of the user. In some exemplary embodiments of the invention, the method for managing a user of a wellness device further comprises reinforcing the user's motivation level. Optionally, reinforcing includes providing at least one incentive to the user. Optionally, reinforcing includes performing activity with a plurality of people. Optionally, performance of a user is compared to performance of others in the plurality of people. Optionally, reinforcing includes performing an activity with an increased chance of success. Optionally, sensing a condition includes user pain detection. Optionally, sensing is based on voice cues from the user. Optionally, sensing is based on physical cues from the user. Optionally, an intensity of an activity which is likely to include pain is reduced. Optionally, the user is notified when pain is expected during an activity. Optionally, activity gradually increases in intensity based on the sensed condition of the user. Optionally, matching includes varying exercise parameters. Optionally, matching includes matching the activity to an expected medical effect. Optionally, activity includes at least one of nudging, massage, or improving blood flow of the user. Optionally, activity includes social interaction. Optionally, activity includes at least one of sleeping, eating, assuming various positions, exercise or moving around. In some exemplary embodiments of the invention, the user is obese. In some exemplary embodiments of the invention, the user is elderly. In some exemplary embodiments of the invention, the user is disabled. Optionally, the condition is a physical condition. Optionally, the condition is a mental condition. In some exemplary embodiments of the invention, the method for managing a user of a wellness device further comprises instructing the user by at least of physical, tactile, movement, vibrational, olfactory, visual or audio cues. In some exemplary embodiments of the invention, the method for managing a user of a wellness device further comprises modifying the activity based on a sensed condition of the user during the activity.

There is thus provided in accordance with an exemplary embodiment of the invention, a method of teaching a wellness apparatus an exercise to be performed on the apparatus, comprising: situating a user of the apparatus in an exercise position in the apparatus; performing a series of steps of the exercise on the wellness apparatus; recording the series of steps for future performance; and, repeating any steps not properly recorded by the wellness apparatus during the performing. Optionally, the teaching is conducted from a remote location. Optionally, the teaching is conducted by a therapist of the user. Optionally, the teaching is conducted by an assistant of the user. Optionally, the teaching is conducted by a family member of the user.

### BRIEF DESCRIPTION OF THE FIGURES

Non-limiting embodiments of the invention will be described with reference to the following description of exemplary embodiments, in conjunction with the figures. The figures are generally not shown to scale and any sizes are only meant to be exemplary and not necessarily limiting. In the figures, identical structures, elements or parts that appear in more than one figure are preferably labeled with a same or similar number in all the figures in which they appear, in which:

FIG. 1 is a schematic block diagram of a wellness system, in accordance with an exemplary embodiment of the invention;

FIGS. 2A-2C illustrate a wellness chair in multiple configurations, in accordance with exemplary embodiments of the invention;

FIG. 3 shows a wellness chair in accordance with an alternative exemplary embodiment of the invention;

FIG. 4 shows the skeleton of the chair of FIG. 3;

FIGS. 5A-5C show various articulation possibilities of the skeleton of FIG. 4, in accordance with an exemplary embodiment of the invention;

FIG. 6 is a flowchart of a daily routine of a user of the wellness system, in accordance with an exemplary embodiment of the invention;

FIGS. 7A-7C illustrate alternative designs for wellness systems in accordance with exemplary embodiments of the invention; and

FIG. 8 illustrates a frame design for an alternative wellness system in accordance with an exemplary embodiment of the invention.

### DETAILED DESCRIPTION OF EXEMPLARY EMBODIMENTS

### General

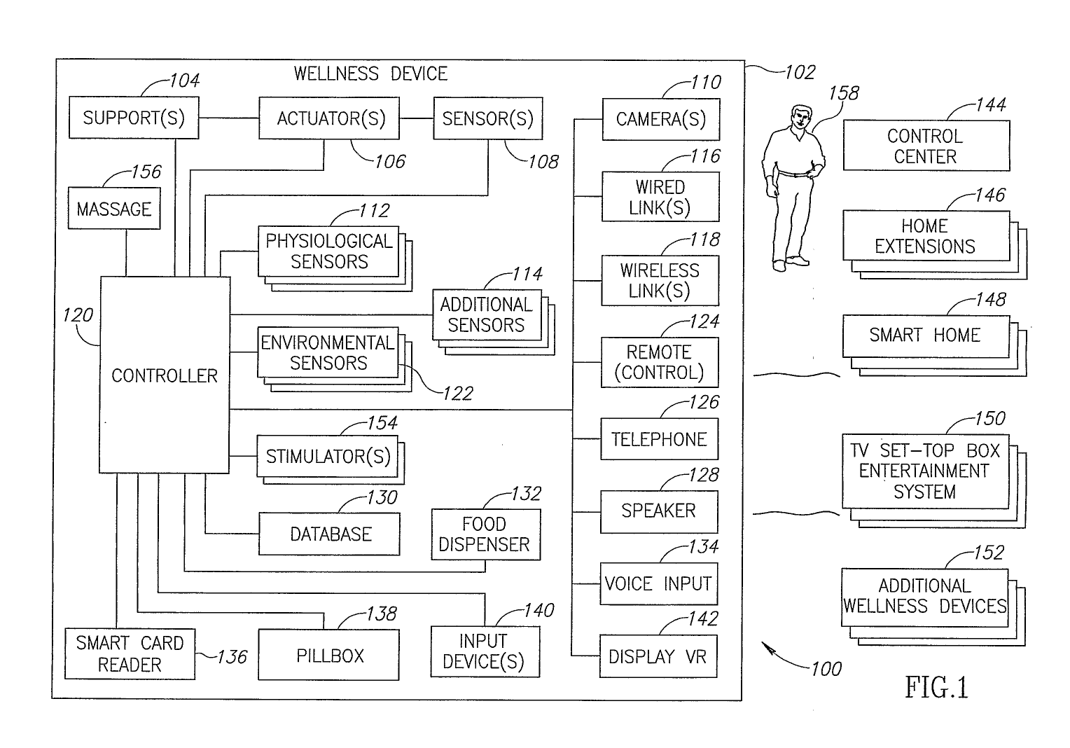

FIG. 1 is a schematic block diagram of a wellness system 100, in accordance with an exemplary embodiment of the invention. System 100 comprises a wellness device 102, for example a chair system as described below. As shown on the right hand side of FIG. 1, additional optional elements outside of wellness device 102 may also be provided, for example a control center 144 at which use of device 102 can be monitored.

Non-physical exercise activity such as socializing, scheduling support, typical daily activities (e.g. eating, sleeping) and controlling other devices is optionally supported. As a result of the varied activities which are performed in device 102, including the daily activities described herein, a user of device 102 remains in device 102 at least an hour a day. Optionally, the user remains in the chair at least 2 hours a day. Optionally, the user remains in the chair at least 8 hours a day. In an exemplary embodiment of the invention, at least 50% of a person's day is spent in the device 102. Due to the assisted-living nature of device 102, a user optionally spends the entire day, or nearly so, in device 102. In an exemplary embodiment of the invention, wellness is supported by one or more of the following optional functions and/or structures of device 102:

(a) Physical manipulation. Portions of a patient (or other user) 158 are supported by one or more supports 104. One or more actuators 106 move the portion or respond to motion thereof (additional details below), and one or more sensors 108 are used to measure one or more parameters of the motion, for example, position, speed, force, tremor, synchronization and other parameters. One or more optional stimulators 154 can be used to assist in guiding motion (e.g., by nudging a limb to remind it to move) or for other uses, for example pain control or therapies. Additional sensors 114 may be provided, for example to monitor movements of other body parts such as eyes and to monitor breathing. Additional details are provided below, including designs for manipulating significant parts of the body. Physical manipulation and/or other functions of device 102 are optionally controlled by a controller 120, for example an electrical or a mechanical controller.

(b) Cognitive Exercising. Controller 120, can provide cognitive exercising, for example using a display or VR (Virtual reality) system 142 and user inputs, such as one or more input devices 140 (e.g., a mouse or a keyboard) and a voice input 134. For both physical and cognitive exercising, device 102 can be used to ensure compliance of the patient with a plan, for example as described below.

(c) Socialization. Device 102 optionally includes one or more tools to assist in socialization of patient 158. In one example, device 102 optionally includes a built-in telephone system 126. In another example, device 102 includes at least one camera 110, which can be used for video conferencing. In another example, additional wellness device(s) 152 are linked to device 102, for example directly (e.g., using at least one wired link 116 or at least one wireless link 118) or via control center 144 (optionally using wired or wireless links), for example for tandem practices or game playing. In another example, speaker 128 (e.g., located in a head rest) is used to amplify ambient sound instead of using a hearing-aid by patient 158. In another example, device 102 is designed to play games with a plurality of players, patient 158 being one player and at least one other player being another person and/or an artificial intelligence. Optionally, the other person is a family member, for example a grand-child of patient 158. A database 130 that is optionally used to store wellness related information may be used for storing contact information for friends and relatives.

In an exemplary embodiment of the invention, device 102 is linked to another, similar device whereby another person besides the patient can work with the patient in parallel. Optionally, the linkage is mechanical. Additionally or alternatively, the linkage is electrical. Optionally, the parallel devices are in data communication with each other. In some exemplary embodiments of the invention, a trainer or assistant sits in one of the parallel devices and assists, teaches and/or demonstrates for the patient activity performed in the device while the patient follows along in the other device.

(d) Comfort, Convenience, Scheduling Support and Daily Activities. A feature of some embodiments of the invention is that device 102 provides comfort and convenience to patient 158. While not strictly wellness (besides that being comfortable helps in feeling well), this may assist in compliance and usage of device 102. One feature of device 102 is that by becoming a central feature in a patients daily schedule (an example described below), activities and monitoring related to wellness can be more easily incorporated into a patient's life and compliance (and safety) ensured (and/or measured and reported).

In an exemplary embodiment of the invention, comfort is provided by a massage unit 156, for example of types known in the art. Such a unit can also provide vibration treatment. Support 104 optionally includes pneumatic or other cushions. Other optional comfort related features are described below.

In an exemplary embodiment of the invention, convenience is provided by device 102 supporting daily activities so that patient 158 does not need to get up, forget or avoid to do important activities. For example, device 102 can include a pillbox 138 for dispensing medication, a food dispenser 132 for dispensing snacks (in particular candy for diabetics), a remote control 124 for one or more home entertainment systems 150 and a link to smart home functions 148, for example remote closing of doors and activation of alarm systems. Automatic dispensing of medication may include, for example, reminder, a sensor to detect if medication was taken and/or a query to the user regarding whether the medication was taken and/or did it have side effects. Dispensing of food is particularly important for the obese as weight control is partially linked to food intake. Scheduling support optionally includes controlling the dispensing food to an obese patient following a dietary schedule.

(e) Monitoring and Safety. In an exemplary embodiment of the invention, device 102 is used to provide monitoring of patient 158. In a simplest sense, device 102 can monitor the use thereof. Optionally, one or more physiological sensors 112 track the physiological effects of manipulation on patent 158 and/or can be used to track health and/or detect problems (e.g., cardiac failure, breathing problems).

In an exemplary embodiment of the invention, one or more environmental sensors 122 are used, for example, to detect fire, smoke, a draft, heat and/or cold. If a problem is detected, a caregiver may be alerted.

In an exemplary embodiment of the invention, one or more home extensions 146 (e.g., sensors with a wireless or x10 link) are used, for example, detecting if a toilet was used or a refrigerator opened. These sensors can be part of system 100 and used to monitor the totality of daily activities of patient 158.

In an exemplary embodiment of the invention, a smart card reader (e.g., contact or contact-less) 136 is used to ensure that the person using device 102 is known. For example, various parameters may be tailored to an individual and using them for another individual may cause problems. This feature can be utilized for home use by a couple sharing same chair (but keeping different daily routines) or at nursing home for multiple users.

In some exemplary embodiments of the invention, a communications link is provided between device 102 and a remote monitoring location. Optionally, the remote monitoring location monitors the health of the patient and/or the operational status of device 102.

### Exemplary Chair

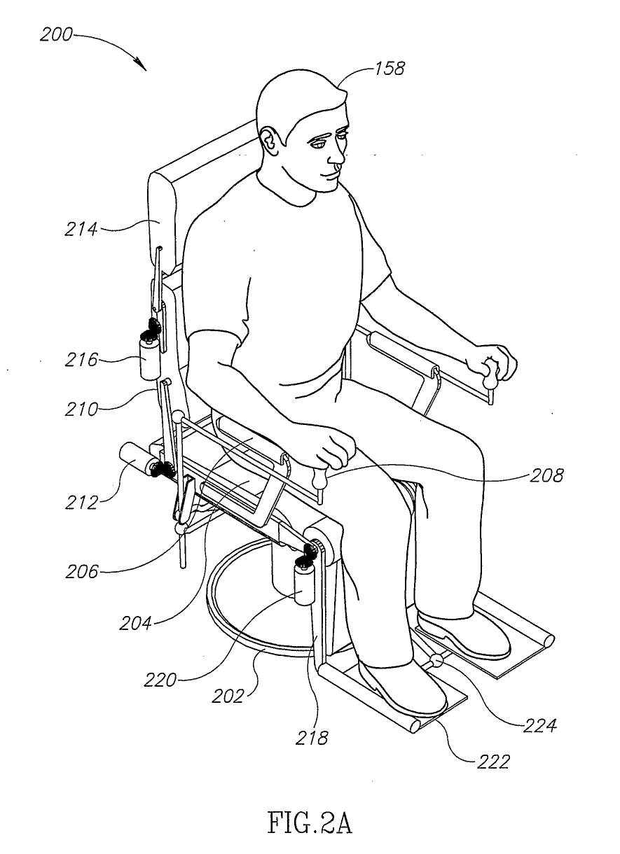

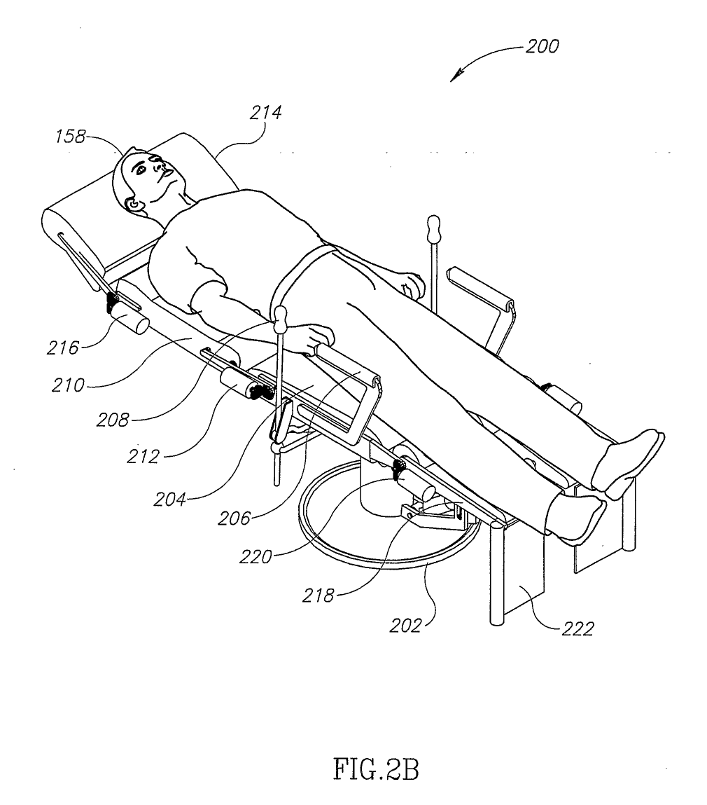

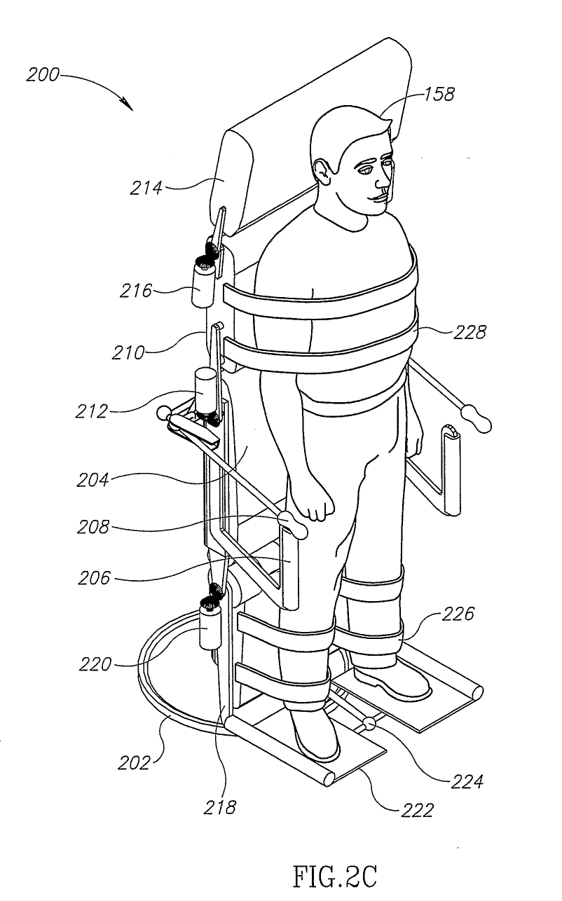

FIGS. 2A-2C illustrate a wellness chair 200 in multiple configurations, in accordance with exemplary embodiments of the invention. As noted above, one embodiment for device 102 is a chair. FIGS. 2A-2C show a particular chair design in different positions, including sitting (FIG. 2A), lying down (FIG. 2B) and standing up (FIG. 2C). A range of intermediate positions anywhere between standing and lying down, for example reclining, can be supported as well. Optionally, the chair is adapted to accommodate an obese patient. For example, the chair is optionally reinforced to handle the additional weight of an obese patient. Optionally, the chair is oversized to allow an obese patient to use the chair comfortably.

Referring to FIG. 2A, chair 200 comprises a base 202, for example a telescoping base, on which is mounted a seat 204. Arm rests 206 are optionally provided and are optionally removable, manually or by chair 200. Not shown is controller 120, which may be, for example, inside base 202 or be a separate controller, for example, a PC computer with suitable software. An actuator (not shown) is optionally provided for changing the orientation of seat 204.

Optionally, an articulated arm 208 is provided, for example for providing physical manipulation of the arm of patient 158, or for assisting in daily activities, for example by moving the arm of patient 158. In the example shown, patient 158 holds onto arm 208. Alternatively, the patient's arm may rest on arm 208 or be attached to it. Optionally, arm 208 includes a self-opening and closing strap so that when required, the strap can close (e.g., in the form of two rigid half circles) on the arm of patient 158 and couple the patient's arm to articulated arm 208.

Power for actuators, the controller and/or other features of chair 200 is optionally by battery, as hydraulic power or using a mines line (not shown).

A back-rest 210 is optionally provided. Orientation of back-rest 210 relative to seat 204 is optionally provided by an actuator 212, for example a motor and gear assembly.

A head-rest 214 is optionally provided. Orientation of head-rest 214 relative to back-rest 210 is optionally provided by an actuator 216, for example a motor and gear assembly. Additional possible motions include height and position relative to patient. It is noted that additional manually adjustable joints may be provided in addition to actuated joints.

A calf-rest 218 is optionally provided. Orientation of calf-rest 218 relative to seat 204 is optionally provided by an actuator 220, for example a motor and gear assembly.

A foot-rest 222 is optionally provided and is optionally movable (actuator not shown). Optionally, foot-rest(s) 222 is rotatable around the vertical axis of a joint 224, optionally using a motor (not shown). As will be described below, this feature may be used to turn a patient from front facing to back-facing while getting in and out of chair 200.

While only one side of the chair has been described, in an exemplary embodiment of the invention, the chair is symmetric with regard to articulation and actuators.

FIG. 2B shows chair 200 in a lying down position. As shown, alternative designs for arms 208 may be used.

FIG. 2C shows chair 200 in a standing position, where joint 224 and foot rests 222 attached thereto may be used to turn patient 158 (described in greater length below). One or more leg straps 226 are shown for holding the legs. As noted above, the straps may comprise rigid elements that selectively open or close and grasp the leg.

One or more straps 228 can be used to hold a thorax of patient 158. As shown the straps enclose the arms as well. In some cases, the straps will not enclose the arms. In an exemplary embodiment of the invention, the tension of the straps is user settable, for example preset for a particular patient 158. In another example a belt is used, for example with a design similar to existing vehicular safety belts.

In an exemplary embodiment of the invention, strap 228 is provided as a hoop which can be selectively opened. Straps can be, for example, manual, or self closing (e.g., magnetic locking or guidance to locking position of strap and buckle).

Optionally, strap 228 is rotatable around its axis so that patient 158 is rotated by the rotation of strap 228. Seat 204 and/or other parts of chair 200 may be made smooth or include rollers, to facilitate such rotation. In an exemplary embodiment of the invention, strap 228 is a flexible metal hoop that is held by a rotating motor at one point on the level of back-rest 210.

### Exemplary Features

In an exemplary embodiment of the invention, one or more of the following features is provided in chair 200.

(a) The chair is multi-position (as shown in FIGS. 2A-2C). Additional positions to those shown may be provided, for example, “feet-up”, “feet-down” and “nearly standing”. In an exemplary embodiment of the invention, the chair is also adjustable for various sized patients and/or patients missing body parts. Optionally, the settings for a patient are stored in the database (or in a user held smart card or memory device) and used to adjust the chair for particular patients.

(b) Limb training. In an exemplary embodiment of the invention, chair 200 is used for individual and/or synchronized training of various limbs and/or other body parts. In an exemplary embodiment of the invention, the amount of resistance and/or assistance for a limb motion is controllable. Massage, vibration and/or electrical or other stimulation may be provided by chair 200 during exercise. In an exemplary embodiment of the invention, low accuracy and/or slow speed of motion and/or lower forces are tolerated in the design of chair 200 due to the generally toned-down activities of elderly persons.

In some embodiment of the invention a mechanism is provided to create a reverse mirror-image of motion (e.g. left arm up right arm down). Some such motions can be mechanically provided by coupling arms 208 mechanically or via controller 120, to each other. Optionally the coupling is selectable, for example under computer control.

(c) Daily assistance. In an exemplary embodiment of the invention, the articulated portions of chair 200 are used to assist a patient in daily life, for example helping the patient stand up or move his arm. In another example, a utensil (e.g., a spoon) is attached to arm 208.

(d) Mobility. In an exemplary embodiment of the invention, chair 200 is mobile, for example including lockable and/or retractable wheel for moving around the house. Optionally, larger wheels, for example suitable for outdoor movement are provided. Optionally, a motor is provided, thereby making chair 200 into a motorized wheelchair. Optionally, a wireless network adapter is provided in chair 200, so that it can remain connected to data sources, monitoring sources and/or network resources even when being moved. Alternatively or additionally, chair 200 may include a cellular modem. Alternatively or additionally chair 200 can move on tracks (physical or electrical) laid in the floor or mounted on a ceiling, for example in a modified house or in a nursing home.

(e) Entertainment. In an exemplary embodiment of the invention, chair 200 includes a built-in entertainment center, for example, a DVD player, display, speakers and/or a radio receiver. Entertainment may also be streamed over network or provided on nearby devices (e.g., a TV display). In an exemplary embodiment of the invention, chair 200 is configured for game playing and/or VR. Optionally, games, VR and/or music are used for providing motivation and/or as part of exercises, for example, for providing visual or audio feedback.

(f) Toilet. Optionally, chair 200 includes an aperture (not shown) in seat 204 so that it can be used as a toilet. A built-in waste storage may be provided. Alternatively, sensors in the toilet room may be provided to track usage thereof by patient 158. Optionally, chair 200 includes wetness sensors or other sensors to detect an incontinence event by the user/patient. Optionally, chair 200 collects other human generated substances, such as blood and/or sweat.

(g) Signs tracking. In an exemplary embodiment of the invention, chair 200 includes physiological sensors 112, such as heart rate, EKG, EEG, EMG, breathing rate, blood pressure and sugar levels. Some of the sensors can be non-contact. Others (e.g., light or ultrasound based) require contact, which may be provided, for example using the straps. Optionally, blood measurements are taken by chair 200 prodding the patient with a thin needle. Emergency medication may also be dispensed in the same manner. The signs can be tracked on the short term or on the long term, for example, osteoporosis can be tracked using ultrasonic bone density measurements. Optionally, chair 200 instructs the patient to move so that the various sensors have a better coupling. Optionally, articulated arms 208 are used to move parts of the patient into a desired conformity.

(h) Modularity. In an exemplary embodiment of the invention, chair 200 is designed to be modular, for example, allowing software and/or hardware components to be attached thereto. For example, various add-ons on arms 208 may be provided, also by third parties. In another example, software modules, for example, games, activities and monitoring programs may be added to an existing chair, to provide additional functionality. As noted above, additional sensors may be provided, for example, sensors which can be mounted on the chair (e.g., using wireless linkage), attached to the patient or located elsewhere in the house (or treatment center). A toilet sensor, for example, can include a smart card reader which identifies the patient using the toilet and reports back to the patient's chair or a central data store.

### Alternative Chair Design

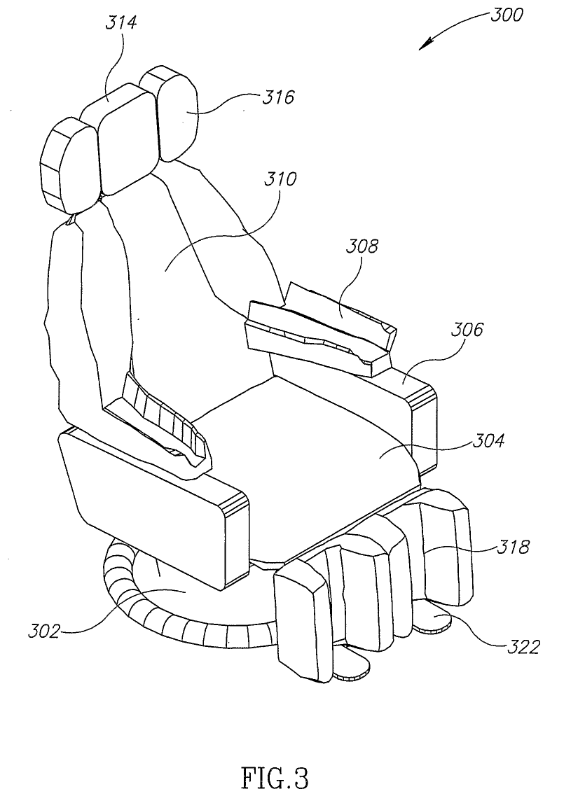

FIGS. 3, 4 and 5A-5C illustrate an alternative design for a wellness chair 300 in accordance with an exemplary embodiment of the invention.

FIG. 3 shows a contoured exterior of chair 300, including a base 302, a seat 304, an arm rest/side support 306, an articulated arm 308, a back rest 310, a head rest 314, a head side support 316, a calf-rest 318 and a foot-rest 322. These numbers generally follow the numbering used in FIG. 2 for functionally similar parts.

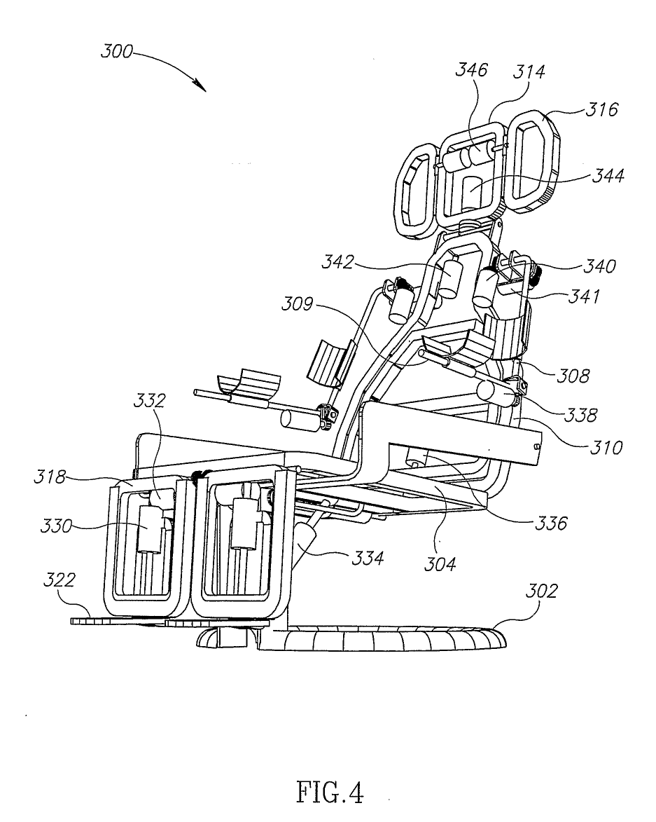

FIG. 4 shows a skeleton of chair 300, illustrating exemplary actuators, which are optionally hidden below the covering of chair 300. The actuators may include sensors for reporting, for example, force, angle and/or speed. In an exemplary embodiment of the invention, the actuator comprises DC, AC brushless and/or stepper motors with suitable gears. Some actuators may be implemented as linear actuators. Optionally, a pneumatic actuator is used, for example, being powered by a central air pressure source, e.g., in a nursing home. In an exemplary embodiment of the invention, the actuator is provided at the joint of the articulated element. In one example, the joint is a universal joint and the actuator comprises two motors, one to rotated each axis of the universal joint. In some embodiments, the actuators are used to provide resistance. Optionally, friction elements, such as brakes are provided for this function. In some embodiments of the invention cables are used to actuate a member, for example by providing a frame above the chair and cable attached to retracting motors on the frame also being attached to a chair portion. It should also be appreciated that in some embodiments one actuator can manipulate multiple members and or limbs e.g. one actuator can move both left and right foot (in a same or opposite direction).

Referring to foot-rest 322, an actuator 330 optionally controls its angles. The orientation of calf-rest 318 with respect to the vertical is optionally controlled by an actuator 332. The length of calf-rest 318 is optionally adjustable (actuator not shown). The orientation of seat 304 (e.g., relative to back 310) is optionally controlled by an actuator 334. Rotation (around a vertical axis) of back 310 is optionally provided by an actuator 336, for example to provide exercising of back. Articulation of arm 308 and a forearm section 309 thereof is optionally provided by a pair of actuators 338 (corresponding to an elbow) and 340 (corresponding to a shoulder). An optional actuator 341 controls rotation of the “shoulder joint” in an orthogonal direction. Rotation of head rest 314 around a vertical axis is provided by an actuator 344. Nodding of head rest 314 (angle relative to back rest 310) is provided by an actuator 342. Rotation of side support 316 (e.g., to hold head in place) is provided by an actuator 346.

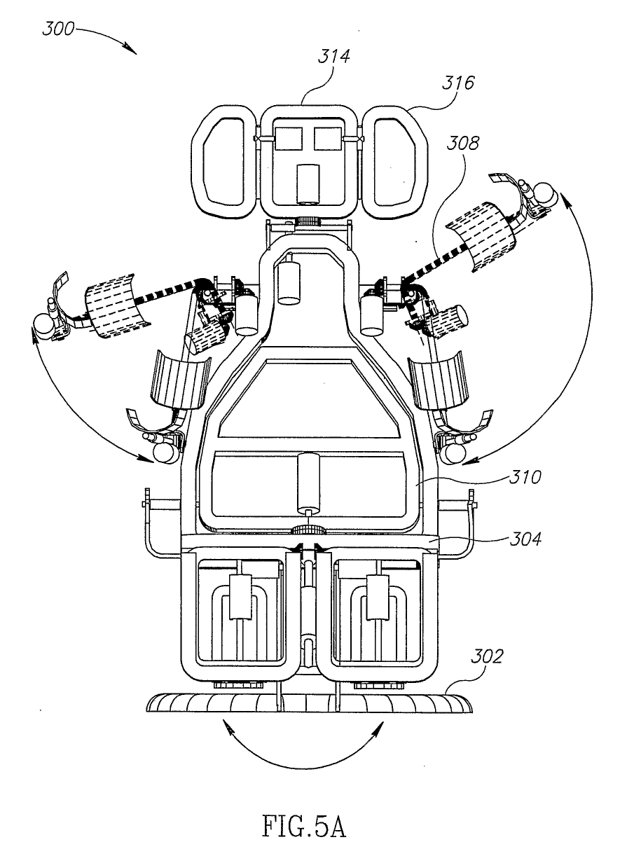

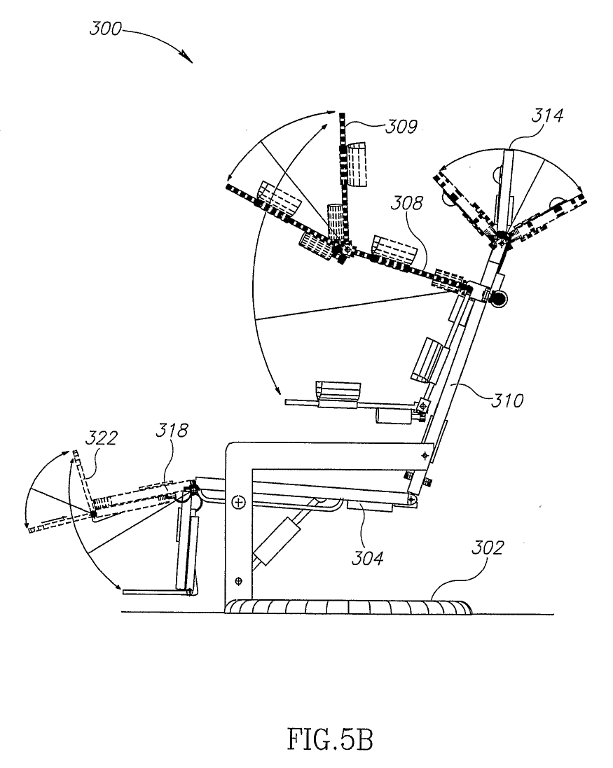

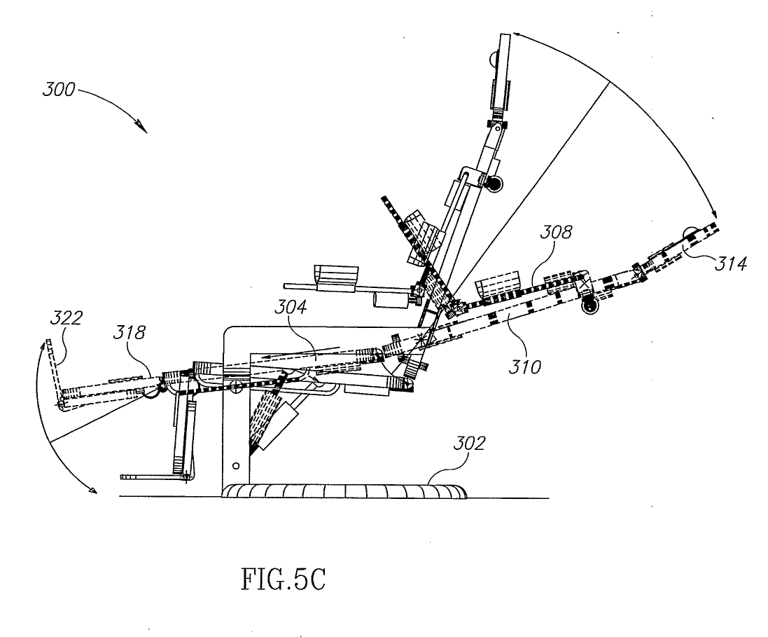

FIGS. 5A-5C illustrate exemplary movements of parts of chair 300.

FIG. 5A illustrates flapping of arms 308. While an actuator is not shown, chair 300 can optionally rotate around its vertical axis.

FIG. 5B shows nodding of head rest 314, lifting motion of arm 308, separate motion of forearm section 309, lifting motion of calf-rest 318 and change of angle of foot-rest 322.

FIG. 5C shows the change in configuration from sitting up to lying down, in which head rest 314 and back 310 recline, seat 304 moves forward and calf-rests 318 raise.

While no “standing up” mode is shown, one may be provided, for example, by adding an actuator to rotate seat 304 and uncoupling arm rests 306 from the seat or back. It should be noted that in general the articulations shown are exemplary. Additional articulations may be provided and/or some articulations dispensed with, in some embodiments of the invention, for example, lifting of knees relative to seat 304 may be provided.

In an exemplary embodiment of the invention, actuators are provided inside the cushions to prevent pressure sores. In an exemplary embodiment of the invention, an array of linear actuators is provided, for example a 1D or 2D array. Pressure sores are optionally prevented by selectively changing which actuators are extended and thus apply pressure against the flesh. Some of the actuators can be, for example, pneumatic cushions or linear actuators

### Issues Relating to Old Age

While wellness devices in accordance with exemplary embodiments of the invention may be used for many uses, a particular use is for elderly population. Some features described herein for such elderly population may be useful for other populations as well. Following is a description of several issues that relate specifically to elderly population and ways in which wellness devices in accordance with embodiments of the present invention can relate to such issues.

In some exemplary embodiments of the invention, the wellness devices and methods described herein are for use with obese patients. While some features provided to obese patients resemble those offered to the elderly, special consideration is made for the large size of obese patients, particularly in the management area and with regard to the structure of the wellness devices. As mentioned above, it is noted that “elderly” is frequently used in this application, however it may also refer to obese, disabled or other patients for which the described apparatuses and methods may be useful.

### Management

Many elderly, disabled and obese persons suffer a reduction in ability to manage, for example, managing of daily schedule, managing of rehabilitation or exercises and managing of social life. Failure to carry out an activity at a required frequency and/or time may lead to deterioration of the person. Conversely, support in management may help persons remain self-sufficient for a longer time, with reduced level of care and/or attention from outside sources (e.g., family, caretaker, old age home, weight loss clinic).

In an exemplary embodiment of the invention, device 102 and in particular controller 120 and center 144 can provide a range of support levels, for example ranging from “reminder” mode to planning and managing a daily schedule, thus supporting a range of elderly capabilities. This range may be brought into play, for example, in elderly persons whose abilities fluctuate and in elderly persons whose abilities deteriorate over time. Optionally, level of management depends on the patient plan (e.g., an insurer and/or service center). Optionally, the plan includes a care-giver visit, a phone call on line support (e.g., accessing the system and the patient) and/or levels of complexity of behavior of the chair.

In an exemplary embodiment of the invention, management and/or monitoring using FIM (Functional Independence Measure) and FIM-like scores. In one example, the scores include functional abilities. Patient 158 is tested periodically (e.g., by chair 300 and/or system 100) and results below par indicate the need for exercises or training to compensate. Optionally, a table of activities is provided with exercises suitable for each lack of the patient. In some cases, a particular exercise may be rejected due to a limited ability of the patient. Optionally, the chair presents various exercise options to the patient and the patient chooses. For example, the chair can present animation of video sequences of the exercise and include information (e.g., pros and cons) such as an expected pain and/or difficulty for the patient.

In an exemplary embodiment of the invention, device 102 provides periodic testing to evaluate decline (and/or improvement) in patient 158. Alternatively or additionally to long term decline, short term assaying may be provided as well. In one example, the patient is asked questions in the morning and is asked to perform one or more mental and/or physical test to assess a current condition. The same mental and/or physical tests are optionally used at a later time, for example the same day, to help determine short term decline (and/or improvement) of the patient. In an exemplary embodiment of the invention, a CVA event is detected by detecting a sudden decline in patient abilities, for example, motion becoming less coherent, voice instructions less clear, asymmetric reduction in ability of body parts and/or reduced ability to follow computer instructions.

In an exemplary embodiment of the invention, management goes beyond basic wellness, for example including social life. In addition, the management can include activities not strictly controlled by device 102, for example, whether or not the patient took pills, ate, went to toilet, etc.

In an exemplary embodiment of the invention, management uses automated sensors, for example, checking for exercises performed or using sensors located in a toilet room of the house or in a kitchen. Alternatively or additionally, device 102 asks questions of the patient. A cross-correlation between questions and sensed events may be used to generate an estimate of deviousness (or forgetfulness) of the patient. A particular example of such a test is a hearing test. System 100 can supply test audio sounds in a range of background conditions and/or a range of attention conditions. Also, being unprepared it may be more difficult for a patient to cheat the test. In another example, the test is a straightforward test, carried out under controlled conditions where the patient is optionally shown the effect of his hearing and/or visual loss by system 100.

In an exemplary embodiment of the invention, the management is completely automated, for example, the controller 120 deciding how to structure the patient's daily life in order to meet certain goals. Alternatively or additionally, human input is provided. Such input can arrive, for example, from patient 158, from the control center, from a caregiver and/or from a family member.

### Motivation

One problem common to many elderly persons is reduced motivation. Often the future looks bleak with a long and painful decline, which in turn reduces the motivation to perform those very actions which would prevent or delay the decline.

In an exemplary embodiment of the invention, device 102 includes apparatus and/or methods to increase motivation of elderly persons.

In an exemplary embodiment of the invention, device 102 provides support for result expectation. In some cases, motivation is related to expectation of achieving results. In an exemplary embodiment of the invention, a display is provided to a patient 158 showing a relationship between an effort level and an expected result (and/or time). In an exemplary embodiment of the invention, what is shown is a progress graph with the length of the x-axis of the graph depending on the effort level. In an exemplary embodiment of the invention, the graph includes concrete results, for example “being able to walk 10 minutes straight” and “being able to write a letter”. In some cases, system 100 “cheats” by setting up easy games for a patient to succeed at.

In an exemplary embodiment of the invention, a graphical progress chart is used. For example, each task is symbolized as an apple and a bin of apples (partly full) is shown to symbolize the progress. This display can optionally be personalized, for example according to the interests of the patient (e.g., painting a picture, knitting a sweater, hitting a bucket of golf balls).

Alternatively or additionally to a purely symbolic activity, real incentives may be provided. In one example, system 100 can display a daily prize (e.g., for patient that tries hardest, progresses most, etc.). A daily listing of winners and tasks for the day may be listed. The task may be normalized to the patient's ability, to level the playing field. Optionally, patients are organized into teams that need to act together in order to win.

In an exemplary embodiment of the invention, coupons and/or discounts are provided based on patients achieving their objectives. In an exemplary embodiment of the invention, the coupons are provided as promotions for restaurant chains or stores. An example of such an incentive is “You can increase the amount of your ACME coupons by 10% if you reach your goal for a week”.

In an article titled “Motivating Elders to Initiate and Maintain Exercise” by Edward M. Phillips, MD, Jeffrey C. Schneider, MD, Greg R. Mercer, MSN, APRN-BC in Arch Phys Med Rehabil 2004; 85(Suppl 3):S52-7, the disclosure of which is incorporated herein by reference, the following formula for motivation is suggested:

Motivation={(perceived chance of success)×(Perceived importance of Goal)}/{(Perceived cost)×(Inclination to remain sedentary)}.

In an exemplary embodiment of the invention, one or more of these products is monitored and/or improved by device 102. For example, the perceived chance of success is made greater by showing progress of self and others. The perceived importance of the goal is enhanced by making the goal concrete and illustrating (e.g., physically) to the patient that the goal can be reached. The perceived cost is reduced by controlling pain, boredom and/or attention requirements. The inclination to remain sedentary is reduced by increasing socialization.

In an exemplary embodiment of the invention, operation of device 102 takes into account that assessment is one of the keys to a suitable training program. The problem is that elderly often under-report their disabilities. In an exemplary embodiment of the invention, by testing an elderly person over time, with random tests, a more precise picture of the disabilities and abilities can be collected. It is noted that some disabilities fluctuate, for example pain due to arthritis can change over time. While a barometer may be provided in device 102 for correlating weather changes with the abilities of the patient, in an exemplary embodiment of the invention, the effect of fluctuating disabilities is assessed by clustering the results of such random testing instead of averaging the results. In an exemplary embodiment of the invention, such testing includes tests of hand eye coordination and/or motor accuracy for one or more of motor, cognitive, perceptive and/or memory, decline.

In an exemplary embodiment of the invention, once a patient is assessed, the patient is posed tasks he/she is expected to succeed in, following the idea of “success begets success”. In an exemplary embodiment of the invention, an initial task is, for example, a challenging but achievable goals, for example, a task requiring work near the limits of ROM, force and/or pain.

In an exemplary embodiment of the invention, system 100 attempts to prevent lingering of bad results. In one example, failure in one exercise, leads to a completely different exercise, optionally one with an increased chance of success (e.g., an easier task or one that the system knows the user has succeeded at recently). In an exemplary embodiment of the invention, if device 102 is not used for a while or following a string of bad results, device 102 goes on-line (e.g., contacts the control center), for example for providing human advice and/or encouragement.

In an exemplary embodiment of the invention, system 100 generates progress reports, for example, to the patient, caretaker, healthcare provider, chair manufacturer or maintainer and/or control center. Alternatively or additionally, periodic “good news” feedback is provided to the patient, for example, emphasizing improvements and hard work, optionally selectively displaying (or prints) results that show that hard work equals improvement.

In an exemplary embodiment of the invention, system 100 also attends to educating the user, specifically on the advantages of using the system. For example, periodic (or during rest period) flashes of information, for example videos or images are used to portray the benefits of using system 100.

In an exemplary embodiment of the invention, system 100 improves motivation by supporting group exercising, for example, with a partner in a same room or remotely (e.g., connected by a network or over the internet). In an exemplary embodiment of the invention, the partners are matched, for example by selection and/or by leveling the playing filed by providing selective assistance to one or both patients, for example, to support weakened abilities thereof. The grouping of patients is optionally re-evaluated after time, for example, as abilities fluctuate, decline or improve. Optionally, the groupings are on an ad-hoc basis, based on daily abilities of the patients.

In an exemplary embodiment of the invention, motivation is improved by providing anatomy to the patient, for example, allowing the patient to make plans on how the system is to be used or to over-ride system planning.

It has been found that women often exercise and/or rehabilitate less than men, especially when elderly. Possible reasons are depression, reduced body image and urinary incontinence, all of which typically affect women more than men. In an exemplary embodiment of the invention, body image is improved using system 100, for example, due to improved blood flow, or using cameras so that the patient can see herself and preen before meeting persons. Incontinence is optionally improved by guiding the patient to perform pelvic floor exercises, by providing electrical stimulation to the pelvic floor and/or by avoiding exercises that cause leaks. In addition, the tracking by the system of user activities and play-back of these activities to the patient can, on its own, improve body image. Alternatively or additionally, incontinence is improved by system 100 generating a schedule of when to expect leaks, etc. and calling human helpers at those times and/or reminding the patient to go to the toilet.

### Pain and Safety

A major concern of patients during recovery and of the elderly in general is pain. In an exemplary embodiment of the invention, device 102, as part of its operation, maps the range of pain for various activities. When providing exercises, device 102 optionally warns the patient when pain is expected. Alternatively or additionally, exercises which include pain are avoided or reduced. Optionally, exercises including pain are clumped together and a pain killer is provided.

In an exemplary embodiment of the invention, pain of the patient is sensed automatically, for example, by detection of physical cues such as a sudden contraction and/or tensioning of muscles or body parts. In an exemplary embodiment of the invention, arm 308 includes a grip for the patient's hand and a sudden increase or decrease in the strength of the patient's grip is used to indicate pain. Optionally, voice cues from the patient are analyzed to detect pain and/or stress. Optionally, a user is queried on-line as to whether he feels pain, more pain than before or less pain than before. Alternatively or additionally, the patient may report pain, for example using a pain scale.

In an exemplary embodiment of the invention, the patient is protected by device 102. In an exemplary embodiment of the invention, certain movements and/or force levels are prevented, for example, by programming or by mechanical limiters. Optionally, one or more tearing pins are provided to tear if a force above a certain limit is applied to the patient. Optionally, the tearing point of the pins is set magnetically. Optionally, Velcro or other hook and loop connectors are used to provide a safety cut-off. In an exemplary embodiment of the invention, a tearing pin is provided in an articulated arm 208. When the arm feels resistance above a certain level, the pin tear and the arm stops moving and applying the force. Resistance can be, for example, the patient's joint locking.

In an exemplary embodiment of the invention, physiological parameters of the patient are monitored, for example, heart rate and blood pressure and exercise is stopped based on unacceptable values for these. Optionally, a shout or groan detector is provided, optionally independent of any voice control, which stops an exercise and/or brings the patient's limbs to a safe harbor position, if a sudden load shout is emitted by the patient.

In an exemplary embodiment of the invention, safety of the patient is enhanced by an ability of device 102 to call a helper if there is a problem or if vital signs of the patient are abnormal. Optionally, device 102 will also detect death of patient 158 while in device 102. Optionally, device 102 prompts patient 158 and records a living will and/or any other instructions, which can then serve as proof of the intent of the patient.

In an exemplary embodiment of the invention, device 102 is configured to improve blood flow in the extremities of patient 158, for example, by raising and lowering the calves thereof and/or by providing various exercises. In an exemplary embodiment of the invention, device 102 causes posture changes of patient 158, for example nudging the patient to roll-over or change position, in an effort to prevent pressure sores. Alternatively or additionally, device 102 provides massage.

In an exemplary embodiment of the invention, device 102 also provides nudging to patient 158 while he sleeps, to ensure posture changes that will prevent pressure sores and/or enhance blood flow. Optionally, one or more limb moving exercises are practiced on the patient while he is detected to be sleeping.

In an exemplary embodiment of the invention, health of patient 158 is enhanced by environmental sensors which can serve to warn of various dangers, such as fire, smoke, carbon monoxide and temperature stress.

Optionally, an on-off switch is provided at a location where a caregiver can easily turn off the chair. Optionally, a live-man switch is provided which turns off the chair if the user lets go or does not respond to an instruction within a time period. Instead of powering down the chair, the chair may be locked in place and/or brought to a safe harbor.

Another optional safety feature is that an exercise starts slowly and only reaches a full speed and/or force after approved by the patient.

### Ease of Use

In an exemplary embodiment of the invention, device 102 is designed to be easy to use. In an exemplary embodiment of the invention, such ease of use is enhanced by one or more of: multi-modal input and/or output. Detailed help including video and/or animation sequences, on-line human helpers, repetitive and slow instructions and/or matching of the operation of system 100 to the daily (and/or weekly, monthly, yearly) schedule of the elderly. Optionally, device 102 instructs a user in an activity and/or use of device. Instruction is optionally physical, tactile, movement, vibrational, olfactory, visual or audio cues.

In an exemplary embodiment of the invention, part of the ease of use is due to customization to the user's preferences. For example, body exercises can be based on tai-chi, ballet or yoga. The selection of the type of exercise can be left up to the user. Different positions may be recorded for different uses (e.g., resting, TV watching and knitting).

In an exemplary embodiment of the invention, customization of system 100 includes learning by system 100 of user preferences, for example, by asking questions about preferences and/or eliciting feedback form the user. It should be noted that the users of system 100 can include one or more of the patient, a nurse, an old-age home attendant, a family member and an attending physician (or other caregivers).

In an exemplary embodiment of the invention, ease of use extends to programmers and manufacturers who are provided with an open architecture to add software and/or hardware to system 100. Exercises are optionally taught to the chair by manually moving parts of the chair while the chair records the motions. The chair may correct the motions to compensate for different sized persons during teaching and training of the patient.

In an exemplary embodiment of the invention, some settings of system 100 are blocked from some users, for example using password protection. Optionally, remote access to such settings by a caregiver is allowed. In an exemplary embodiment of the invention, device 102 includes a firewall to prevent unwanted access to the device, which may be dangerous for the user. Optionally, a watchdog routine is provided independent of other software which watches the behavior of device 102 and stops the device if abnormal and/or dangerous behavior is detected.

### Dealing with Limitations

In an exemplary embodiment of the invention, system 100 is configured to deal with (e.g., compensate, avoid and/or overcome) limitations typical among the elderly.

In an exemplary embodiment of the invention, the limitation of short term memory difficulties is dealt with by providing repetitions and reminders. In some cases, patients can compensate by replacement, so images may be used to replace names. This may be used, for example to report telephone messages.

In an exemplary embodiment of the invention, the limitation of limited strength and muscular control is dealt with by providing exercises with variable parameters such as those that vary continuously in resistance and force (or with small increments like 100 gr) as compared to standard weight lifting devices, which typically have large steps.

In an exemplary embodiment of the invention, system 100 deals with disease for which medication is taken by matching the activity to the effect of the medicine. For example, after a period in which the time and duration and/or response curve of a pain medication is assessed by system 100, exercises are presented to a patient at a suitable timing after pain medication is taken for arthritis. Conversely, if system 100 detects that a patient is having difficulty with an exercise it may suggest taking medication. Similarly, a person being treated medically for Parkinson's disease often manifests modes, such as locked, tremor and normal. System 100 optionally detects these modes and selects activities for the patient commensurate with these modes. Alternatively or additionally, system 100 can suggest to a user more optimal time to take medication, based on the interaction of the medication with the patient's life.

Tracking of the pharmaco-dynamics of medication may also have other uses, such as medical studies and detection of side effects. Exemplary studies include dosage optimization and schedule of medication both for wide population and for specific individuals.

Another issue with the elderly is comfort. In an exemplary embodiment of the invention, comfort is enhanced by one or more of providing pillows, massage, vibration, heat, electric field therapies and low level IR. Optionally, system 100 learns which positions are comfortable to the patient, for example, using questionnaires, by noting fidgeting or noting in what position the patient falls asleep. Optionally, system 100 deliberately experiments with a range of positions so as to better determine an optimal or a set of optimal positions for the patient. Possibly, different positions are preferred for different activities.

In an exemplary embodiment of the invention, system 100 measures, monitors and/or trains the patient in maintaining correct posture and/or changes in posture. Training can include, for example, showing a patient an example and then measuring if the example was met. In an exemplary embodiment of the invention, the example is presented visually, acoustically (e.g., instructions) and/or kinesthetically (e.g., by moving parts of chair 200). In an exemplary embodiment of the invention, an example of an exercise is performed for device 102 and/or system 100 while the patient is in it. Optionally, the steps of the exercise are demonstrated from a remote location. Optionally, device 102 and/or system 100 record the steps of the exercise to be performed. Optionally, these steps are played back for the patient to familiarize the patient with the exercise. In some exemplary embodiments of the invention, a therapist performs the steps. Optionally, a family member or an assistant performs the steps.

In an exemplary embodiment of the invention, device 102 enhances convenience for the patient by including one or more of personal stationary, a voice recording and/or dictating system, voice activation control, a universal remote control, a cellular or other wireless telephone and/or an integrated PC computer (e.g., for word processing or game playing).

In an exemplary embodiment of the invention, device 102 includes a tray (e.g., a lap tray, not shown) and/or eating utensils. As noted above, arms 208 can have the utensils attached thereto and be used to assists the patient in eating.

In an exemplary embodiment of the invention, system 100 compensates for lost abilities, in daily life and with regard to operating system 100. In an exemplary embodiment of the invention, motor capabilities are enhanced by device 102 helping in limb movement and/or reducing tremor.

In an exemplary embodiment of the invention, cognitive abilities are compensated for by reminder and by providing simple instructions. Vision and/or audio recognition by the chair may be used to compensate for patient limitations in these areas, if, for example the chair translates its perceptions into a modality understandable by the patient and/or the perceptions are presented slowly and/or repetitively enough.

In an exemplary embodiment of the invention, visual disabilities are compensated for by providing large letters and high contrast. Optionally, one of the cameras of the system is slaved to the patient's head or hand and used to capture enlarged images to assist the patient in understanding the surrounding world.

In an exemplary embodiment of the invention, auditory disabilities are compensated for by speakers near the patient's head being used to provide amplified audio to the patient. A directional microphone is optionally provided for acquiring the sound. Optionally, the direction of the microphone is made to match the gaze direction of the patient. The speaker system can also be used for telephone, television and/or music listening.

In an exemplary embodiment of the invention, system 100 tracks the decline of a patient, so that the patient's actual and expected abilities match better. In an exemplary embodiment of the invention, system 100 is used to continue with rehabilitation exercises and/or ability maintaining exercises also when the patient is sick and/or after adverse health events. This continuation may be important to prevent loss of function which may be difficult to recapture later. Optionally, as the patient's abilities are reduced, a pre-defined priority listing or a human input is used to decide where to invest the patient's limited abilities. Optionally, this decision is made on the fly by analyzing the patient's abilities.

As noted above, system 100 is optionally configured to be able to deal with a range of decline situations thus, a same chair and/or look and feel can follow a patient over a long period of time, for example, 1, 2, 4 or more years and a range of decline, for example, a 20%, 40%, 60% or more decline in one or more of motor, cognitive and/or mental abilities.

In an exemplary embodiment of the invention, system 100 urges patient 158 to perform exercises that combat osteoporosis and/or exercises that improve balance.

In an exemplary embodiment of the invention, system 100 attempts to combat arthritis by encouraging the patient to take medication, perform exercises and learn how to avoid pain (e.g., by teaching motions that avoid pain). Optionally, some painful motions are carried out, to ensure maintaining of a range of motion. General stiffness is optionally combated by providing the patient with warm-up exercises and/or vibration and/or heat, to stiff muscles and/or joints.

In an exemplary embodiment of the invention, exercises provided to the patient take into account weakness of the patient (e.g., exercise difficulty), fatigue (e.g., exercise duration) and/or numbness (e.g., no hard contacts). In an exemplary embodiment of the invention, the timing of the exercise is divided over the day, so that there is no large clump of exercises which may seem too over powering to the patient. In an exemplary embodiment of the invention, a 15 minute session is broken up into five 3 minute session. Certain exercises may be scheduled before or after other activities such as eating.

In an exemplary embodiment of the invention, system 100 can also include controllers for remote devices, for example, oxygen tanks, humidifiers and/or air-conditioners (e.g., temperature and/or humidity control and/or filtering). Optionally, device 102 includes a sensor near the patient's head which can measure, for example, oxygen content and/or carbon dioxide content and thereby detect shortness of breath. Alternatively or additionally, breathing problems are detected by detecting breaths and measuring their length, depth and/or other properties. Optionally, sensors for metabolic compounds are provided, for example, for detecting hydrogen (e.g., fructose injection), acetone, ketones and other materials, which can indicate a metabolic state of the patient, possibly a dangerous state and possibly merely an indication that dinner was skipped or that the patient has a disease of some type. Optionally, one or more sensors, for example for blood testing are provided and the user may be requested to uses these sensors (e.g., the sensor takes drop of blood and then analyses it), for example, depending on a schedule or on system or human decision. Optionally, device 102 is equipped to mount other devices, for example oxygen tanks, humidifiers and/or air-conditioners.

### A Day in the Life

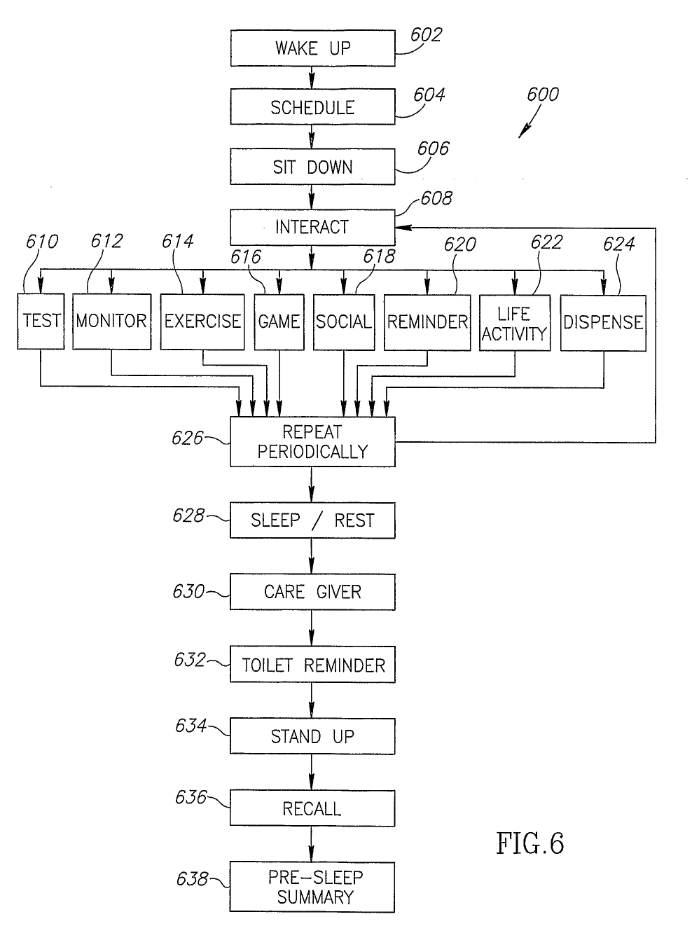

FIG. 6 is a flowchart 600 showing a day in the life of a patient using system 100 in accordance with an exemplary embodiment of the invention.

At 602, the patient wakes up. Optionally, system 100 generates a wake-up call, for example using a wireless alarm clock in the patient's room. Optionally, system 100 also turns on chair 300 at this time and/or turns on a radio and/or a television.

At 604, a daily schedule is recited or shown to the patient. Optionally, a nurse is notified to prepare breakfast, tea, etc. The schedule may be printed out, for example, for the patient and/or a nurse. The schedule optionally includes social and entertainment matters, such as friends to call, holidays and a TV schedule. The patient may make requests or changes at this point, as well as at other points, in some embodiments of the invention and optionally within certain limitations (such as requiring a minimum of exercising).

At 606, the patient sits down in chair 300 (unless the patient spent the night in the chair). It should be noted that the patient may do various activities before sitting down, such as eating breakfast. Optionally, chair 300 reminds patient 158 to sit if he does not come at an allotted time. Optionally, chair 300 assists in the sitting activity (more details below).

At 608, chair 300 interacts with the patient, for example, providing simple tests and asking if the patient ate, etc. some of this interaction is small-talk, meant to place the patient at ease and some may be used for testing. In an exemplary embodiment of the invention, the response of the user are used to calibrate the exercises and/or other activities of the day, and/or to suggest medication.

During the major part of the time the patient sits on chair 300, a plurality of activities may be carried out in parallel (626), optionally at a users initiation, optionally with urging by system 100 if a certain activity (e.g., exercise) is overdue. Exemplary activities include one or more of: testing the patient (610); monitoring patient parameters (612); exercise (614), e.g., for rehabilitation (e.g., after CVA) and/or for maintaining ability; playing games (616); social activities (618), such as telephone calls, visits and on-line chatting; reminders (620), e.g., to take medication, call people, go to outside activities; life activities (622), e.g., various activities the patient wants to do and can do while sitting down; and dispensing of medication, water and/or food (624).

At 628, patient 158 sleeps or rests. System 100 may provide a reminder to do so or it may note that the patient is deteriorating and sleep is a good idea.

At 630, a caregiver may be paged, for example to assist the patient or to provide food. Maintenance personnel may be called to maintain the chair.

At 632, the patient may be reminded to go to the toilet, for example, based on a time schedule or based on a monitoring of injected fluids. Optionally, chair 300 includes a scale which measures the weight of the patient over time, detecting, for example, weight gain and weight loss and/or food/beverage intake and voiding. This is particularly useful for obese patients in order to measure their improvement or decline in weight control.

At 634, the patient may be helped up and/or reminded to leave the chair and walk around.

At 636, the patient may be reminded to return, optionally calling the patient on his cell phone.

At 638, a pre-sleep reminder is issued to the patient describing the next day's activities and/or highlights of the current day.

### Usage Examples

In an exemplary embodiment of the invention, chair 300 is used in nursing homes and/or day care centers and/or weight control clinics. Optionally, a central monitoring station is provided for the nursing help. Alternatively or additionally, status of the various chairs is transmitted to a mobile station, such as a PDA, so the nurse can be up-to-date even when walking around. Optionally, chairs 300 include motorized motors which can be used to move the patients around. Optionally, the nurses or a control station can command one or more chairs to activate and move the patients from one location to another, such as a dinner hall or a lecture hall or a fire escape. Optionally, a user override is provided for the patient. Such a chair may also be used in small regional clinics or at home. It is noted that in some usages, the chair will be dedicated to a particular patient who will spend several hours a day in it. In other cases, the chair will be shared by a small number of persons or possibly by a large number of persons. Optionally, when a patient is placed in or approaches a chair, the chair reads out a smart card or other wirelessly (or contact) accessible storage device to read at least the patient's ID. Data regarding the patient may be on such a smart card or may be stored in a central database or in controller 120. The chair then configures to match that patient's needs. Optionally, preset buttons are provided on the chair for a user to select one of several settings. In a case of a chair being used for a small number of persons, automatic detection of the user is possible, for example, based on weight, height or facial features (e.g., using the camera).

In an exemplary embodiment of the invention, chair 300 or its like is provided in a gym, possibly a gym aimed at the elderly or a regular gym. When entering the chair, the person using the chair can perform safe exercises.

In an exemplary embodiment of the invention, chair 300 is configured for group use, for example, including two chairs connected together and possibly sharing a single controller, database, memory and/or CPU. This can allow couples to share the experience of the chair. As noted above, chairs can be networked to allow group activity, including, for example, a set of chairs in a same gym, for example, for morning exercises in an old age home. Optionally, as noted above, chairs are used to provide games and/or a VR experience to patients. Optionally, the chair controls the TV set-top box, for example, to play scenery commensurate with an exercise being performed or to display “rewards” for work well done. In the particular example of games, chair 300 can provide support when playing against healthy persons, for example, the chair can assist the patient in moving a limb (e.g., for chess playing), steadying a joystick (e.g., in shoot-them-up games) and whispering advice (e.g., in thought requiring games).

In an exemplary embodiment of the invention, system 100 also generates showoff reports, for example, reporting on patients who advanced or on high scores. Such results can be sent by e-mail or voice mail to patients. Optionally, the information is presented (e.g., as high-scores) on a display of chair 300.

In an exemplary embodiment of the invention, chair 300 is treated as a therapy, in that a written prescription is provided for patients. Optionally, the prescription uses barcodes or is in other machine readable form so that chair 300 can identify the prescription and follow it. Optionally, the chair also reports back to the prescription giver the effect of the prescription. Such a prescription optionally includes tests to be carried out, including tests that must be carried out long term, for example, over hours, days and/or weeks.

### Additional Optional Features

In an exemplary embodiment of the invention, chair 300 includes features not directly related to physical health. In an exemplary embodiment of the invention, chair 300 can serve as an activity center for the patient. For example, chair 300 can include a personal scheduling program, with reminders (e.g., “take your pill”) and notifications (e.g., “your daughter called”). Chair 300 can optionally also be called up by friends, family and/or caregivers to learn about the patients situation (to the extent that the patient did not request privacy settings) and/or to determine when the patient can be visited (e.g., is awake, not exercising). Optionally, the chair, using an UVR (interactive voice response) system or a web interface (e.g., chair 300 may include a web server or may be a client for a suitable service), allows visitors to set up appointments with minimal interaction with the patient.

Chair 300 optionally includes a built-in telephone and/or docking station for a cellular telephone. Video conferencing abilities may also be built in.

In an exemplary embodiment of the invention, chair 300 supports sleep or rest of the patient, for example, by dimming lights (e.g., by a connection to a smart house system (148 on FIG. 1) or by dimming a built-in reading light), quieting devices such as TVs, screening telephone calls and/or providing a display that says “please do not disturb”. Optionally, chair 300 wakes up the patient, gradually, for example once a set amount of sleep time has passed. A connection to a smart house system can include also connection to other systems, such as alarms and interior and exterior cameras. Optionally, when installing chair 300, BlueTooth or other wireless controllers are installed in the house to facilitate interaction with chair 300.

Chair 300 may also include various software for use by the patient, for example, a customized version of a bookkeeping software that is configured to include types of payments made and received by elderly, such as medical expenses and pensions.

In an exemplary embodiment of the invention, chair 300 includes a scent dispenser. Optionally, the scent is used to mask smells associated with disease, medication and/or incontinence, for example, when visitors are expected. Alternatively or additionally, the scent is used dispensed automatically if a patient does not eat and states he has no appetite. Alternatively or additionally, the scents are dispensed for the pleasure of the patient. Alternatively or additionally, the scents are used to complement VR scenery. Alternatively or additionally, chair 300 includes an order absorber. Optionally, a caretaker is reminded by chair 300 when it is time to change the order absorber.

### Assistance in Sitting and/or Standing

In an exemplary embodiment of the invention, chair 200 or chair 300 are used to assist a patient in entering the chair or in leaving the chair. Considering FIGS. 2A-2C, it can be noted that chair 200 can change from a sitting position to a standing position and carry the patient up with it. Once in standing position, the patient can walk away from the chair.

In a less extreme example, arms 208 can serve as a moving hand rest which the patient grasps and which help him stand. In another example, chair 200 can serve as a system to train the patient in standing up, for example, by measuring pressure applied by the patient to hand rests, articulated arms and/or other seat parts and notify the patient if the pressure is asymmetric and/or insufficient.

For assistance in sitting down, in an exemplary embodiment of the invention, the patient backs up to the chair (while the chair is in standing configuration) and then straps in and the chair changes to seated configuration. A patient with a walker can generally carry out this maneuver. Optionally, the walker can lock into place on the foot-rest.

In an exemplary embodiment of the invention, the foot-rest rotates around a vertical axis, for example the foot rest being in the form of a “Lazy Susan” (rotating plate). Then, the patient walks up to and faces the chair and the foot-rest rotates and rotates the patient with it.

In another embodiment, the patient faces the chair and an articulated arm extends and the patient holds onto the arm while turning. The other articulated arm may support and/or guide the patient. It is noted that the articulated arms may rise so that they are at a more comfortable height to lean on.

Lifts from wheelchairs as known in the art may be used as well. Optionally, the arm rests/arm supports can rotate out of the way to allow sliding from the wheel chair to the chair. Optionally, the articulated arms are used as a support and/or to help move the patient.

Optionally, the base of the chair can translate (not shown), for example including a rail for translation. Thus, when the patient faces the chair, the chair rotates round the patient to face the patient's back. A camera is optionally used to ensure the patient properly located vis-à-vis the chair. Optionally, sitting is initiated by voice command or using a remote control by the patient.

In an exemplary embodiment of the invention, chair 200 or 300 include a clip for a cane of the patient. Optionally, the cane is lifted up when the person stands up, for example, using an actuator.

### Exemplary Specific Uses

Described below are examples of specific uses to which chair 200 and/or 300 may be put.

In an exemplary embodiment of the invention, chair 200 is used for recovery after CVA and/or fractures (e.g., femur fracture).

In an exemplary embodiment of the invention, chair 200 is designed to allow modular exercising and global exercising, for example, exercising body parts separately or together. In one example, only hands or only feet are exercised. In another, coordination between disabled portions and healthy portions is exercised.

In another example, chair 200 is used for balance exercises, for example, by using the articulated arms to cause the patient to reach past his center of balance (e.g., moving with the arm or trying to catch the arm) and with various chair positions, including an inclined seat. Optionally, the chair can wobble, for example using a suitable actuator. Balancing while standing can also be trained, for example, using straps and/or articulated arms to prevent the patient from falling out, while measuring the forces applied by off-balance movements of the patient.

In an exemplary embodiment of the invention, chair 200 is specifically used to practice parts of the body that loose their sensitivity, for example, ankle proprioception and filling at the foot. These lacks of sensitivity often call falling, with disastrous results, in the elderly.

As noted above, various accessories may be attached to chair 200, for example, attachments for ankle, hand, elbow, knee, fingers, neck and/or torso. Such attachments may include, for example, actuators and sensors. Optionally, suitable software is bundled with the accessory. Optionally, the software is stored on the accessory, for example in flash memory and is downloaded to controller 120 when the accessory is attached to chair 200. Additional exemplary accessories are for perceptive abilities (e.g., audio and visual displays, haptic and/or scent attachments). Optionally, music is used for feedback to the user and/or to guide motions.

In an exemplary embodiment of the invention, one or more of the following exercise modes is provided by the chair:

(a) Passive—chair moves patient;

(b) Assistive—chair helps patient with a move initiated by patient;

(c) Resistive—patient works with settable loads;

(d) Balance exercises;

(e) Standing up and/or sitting down exercises;

(f) Exercises that combine motor skills and cognitive and/or perceptive abilities;

(g) Cognitive exercises, for example, to maintain patient alertness;

(h) Slave and master exercises, for example using gestures and/or examples practiced on one chair or using a position sensing device (or e.g., a magnetic sensor or a camera), to control the motions and/or allowed motion and/or parameters of exercises on a chair.

In an exemplary embodiment of the invention, a range of motion and/or a range of pain can be set for each limb and/or joint.

### Design Variants

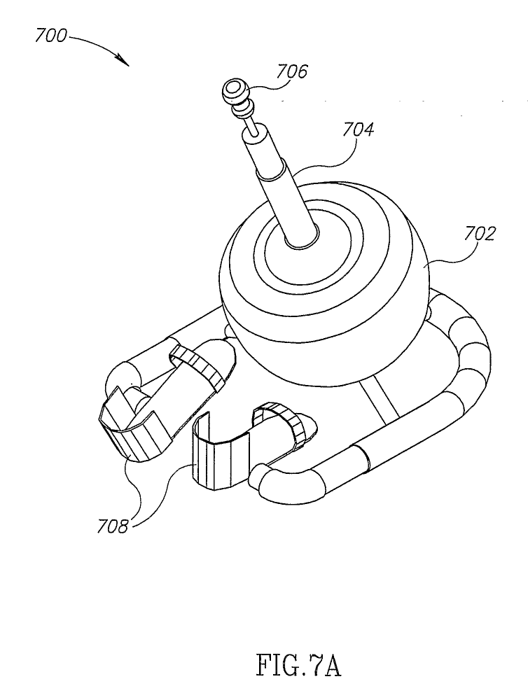

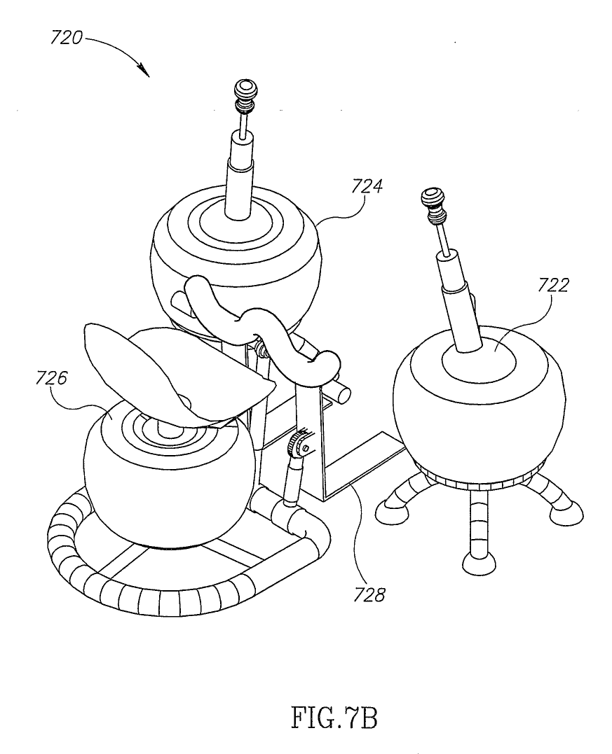

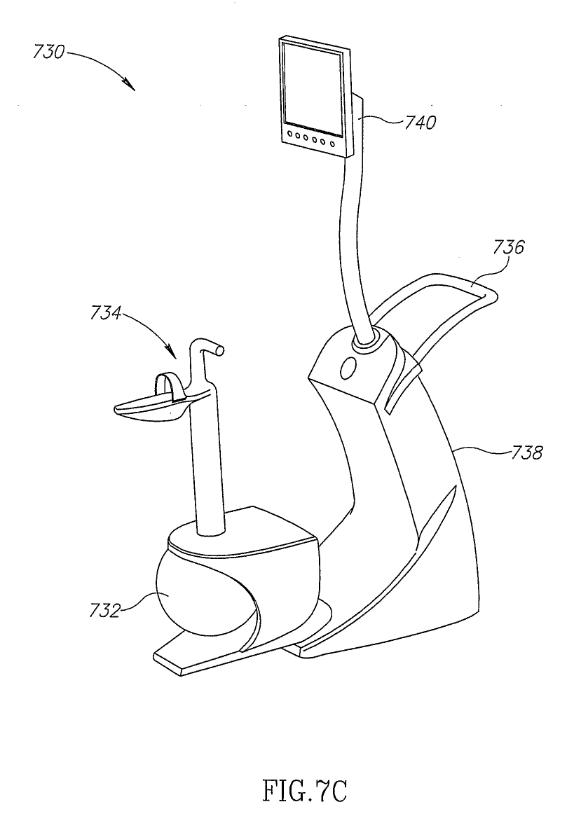

FIGS. 7A-7C show alternative implementations of device 102.

In FIG. 7A, a device 700 includes a ball element 702 from which extends a telescoping rod 704 having an attachment (e.g., a grip) 706 at its tip. A pair of foot pedals 708 for exercising a foot are shown. A chair is not shown and various chair types can be used, including chairs 200 and 300. Optionally, a massage chair (or other multi-position chair) is used and a controller is used to move the chair to a position that matches an exercise to be performed. Optionally, device 700 includes one or more retractable motorized wheels so that it can be moved away form the chair with minimal effort. Optionally, the patient uses a remote control for such motion.

FIG. 7B shows a device 720 including two ball elements 722 and 724 similar to element 702 and a chair sitting on a ball element 726 (e.g., for training balance). A leg lift 728 is optionally provided for leg lifting (e.g., for blood flow enhancement and/or for balance training).

FIG. 7C shows a device 730 including a ball element 732, a grip 734 including a wrist rest and a handle attached to ball element 732 and a display 740, for example for showing instructions. One or more retractable wheels may be stored in a body 738 of device 730. A handle 736, optionally foldable may be provided for moving device 730. A separate chair is optionally provided or standing exercises are performed. Lying down exercises can be performed from a bed.

In an exemplary embodiment of the invention, system 100 (FIG. 1) includes a mobile robotic element, which can be used, for example, to wheel into a room and call the patient, or as a proxy with a camera to show the patient views of parts of his house.

While a chair is shown in the above embodiments, this is not an essential feature. Rather, adaptation for needs of elderly population can be provided in other devices, for example, gym devices. One example is a bicycle including an activity center. Another example is an abs trainer including weight safety controls as described above. Another example, is a simplified version of FIG. 7A, including a rod with two articulated handles thereon. It should be appreciated that not all features must be provided on all devices for the elderly.

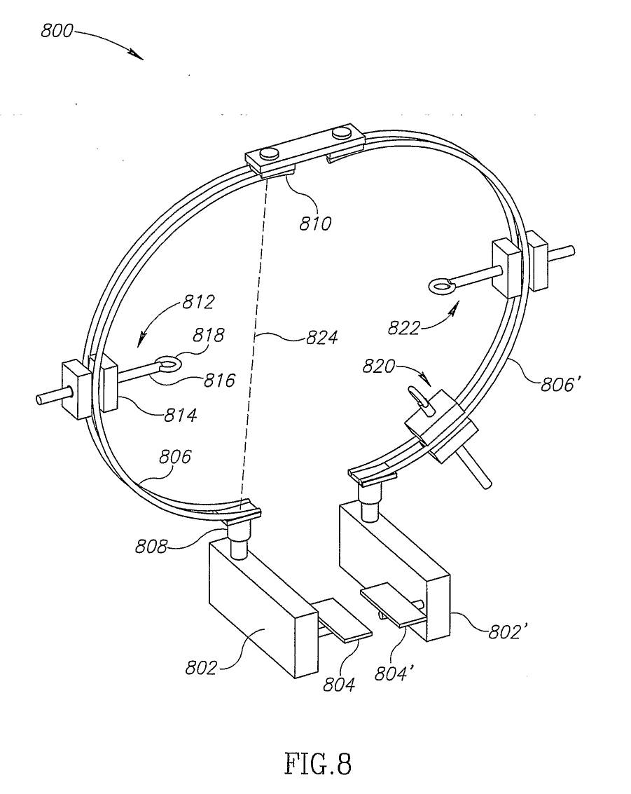

FIG. 8 shows an alternative exercise device 800 in accordance with an exemplary embodiment of the invention. An optional lower limb training section includes a base 802 having a pedal 804 mounted thereon. Optionally, the pedal is capable of rotary motion relative to a horizontal axis (e.g., as in a bicycle) alternatively or additionally to rotation around its axis. As shown, two base sections 802 and 802′ (with a pedal 804′) are shown. A chair is optionally placed between the base sections. An optional upper limb section comprises at least one arcate element 806 on which at least one limb unit 812 is attached. Arcate element 806 is optionally hinged so that it can rotate around an axis 824. A first hinge 808 attaches arcate element 806 to base 802. A second hinge 810 may be used to couple arcate element 806 to its mirror element 806′. Limb unit 812 optionally includes a base section 814 capable of manual, motorized and/or resistance to motion along arcate element 806. A handle 816 optionally telescopes from base section 814 and includes an optional grip 818 at its end. Optionally, the grip is exchangeable. One or more limb units 820 and 822 may be provided on arcate element 806′.

In use, a patient walks into device 800, between base sections 802 and 802′ and holds onto grips 818. Rotation of arcate sections 806 in combination with telescoping motion of handle 816 can be used to achieve any spatial position of grip 818. Rotation of handle 816 is also possible. Actuators (not shown) and sensors (not shown) may be used as described in FIG. 1.

For storage, arcate elements 806 and 806′ may fold to over base sections 802 and 802′, such as around axis 824 shown for the left arm.

Device 800 is optionally used to teach gait, for example, teach the correct motion of feet and arms together. Articulated arms for engaging the thigh and/or knee may be provided as well.

In an alternative embodiment, base sections 802 and 802′ comprise arcate elements as well, for example, elements lying on the floor or vertical elements, for example perpendicular to elements 806. Leg attachments or pedals may be provided instead of grips 818.

It should be appreciated that while the above application has focused on the elderly, the uses of devices in accordance with the present invention are not limited to the elderly and may, instead, be applied to any persons undergoing rehabilitation or to otherwise healthy disabled individuals, for example, amputees, persons with cognitive limitations and/or retardation. In another example, a wellness chair is used by a pregnant woman during a pregnancy watch period.

In addition, the features described above can generally be used in systems that are not wellness systems. For example, the device of FIG. 8 can be used for exercising or for practicing tai-chi.

It should be noted that while the application has focused on the concrete devices, such as chairs, wireless sensors and stimulators may also be used, for example, to assist in providing feedback where sensors are missing or on non-rehabilitation systems.

Various designs for robots and positioning devices (e.g., hexapods) are known in the art. It should be appreciated that various ones of the statements described herein may be adapted for such robots and/or positioning devices, in accordance with exemplary embodiments of the invention. Alternatively or additionally, software may be provided for such robots and devices for carrying out various ones of the methods described herein, all in accordance with exemplary embodiments of the invention.

The following provisional and PCT applications, the disclosures of which are incorporated herein by reference, describe devices and/or methods that may be used in conjunction with embodiments of the present invention.

U.S. provisional application No. 60/604,615 filed on Aug. 25, 2004, the disclosure of which is incorporated herein by reference, describes taking the effects of brain plasticity into account. The methods described herein may use EEG or fMRI as an input for deciding, for example, on feedback or type of device mode to use.

A PCT application titled “Methods and Apparatus for Rehabilitation and Training”, serial number PCT/IL2005/000142, describes devices and methods which may be used for rehabilitation.

A PCT application titled “Methods and Apparatuses for Rehabilitation Exercise and Training” serial number PCT/IL2005/000136, describes chair based rehabilitation and balance rehabilitation.

A PCT application titled “Gait Rehabilitation Methods and Apparatuses”, serial number PCT/IL2005/000138, describes rehabilitation of gait, in parts and in total.

A PCT application titled “Rehabilitation with Music”, serial number PCT/IL2005/000137, describes using music as a feedback and/or to guide rehabilitation.

A PCT application titled “Neuromuscular Stimulation”, serial number PCT/IL2005/000135, describes stimulating a paretic limb while moving the limb or otherwise supporting the motion of the limb. EMG measurements, for example of healthy limbs are optionally used as part of the teaching of the present application for deciding on stimulation and/or supported motion of a paretic limb.

A PCT application titled “Fine Motor Control Rehabilitation”, serial number PCT/IL2005/000139, describes rehabilitation of fine motor control and using a robotic arm as an assistant in daily living, for example, to help feeding.

It should be noted that the rehabilitation devices described herein are optionally usable not only at a home but also at care centers, such as old age homes, hospitals and rehabilitation centers.

It will be appreciated that the above described methods of rehabilitation may be varied in many ways, including, omitting or adding steps, changing the order of steps and the types of devices used. In addition, a multiplicity of various features, both of method and of devices have been described. In some embodiments mainly methods are described, however, also apparatus adapted for performing the methods are considered to be within the scope of the invention. It should be appreciated that different features may be combined in different ways. In particular, not all the features shown above in a particular embodiment are necessary in every similar embodiment of the invention. Further, combinations of the above features are also considered to be within the scope of some embodiments of the invention. Also within the scope of the invention are kits which include sets of a device, one or more tearing pins, one or more attachments and/or software. Also, within the scope is hardware, software and computer readable-media including such software which is used for carrying out and/or guiding the steps described herein, such as control of arm position and providing feedback. Section headings are provided for assistance in navigation and should not be considered as necessarily limiting the contents of the section. When used in the following claims, the terms “comprises”, “includes”, “have” and their conjugates mean “including but not limited to”. It should also be noted that the device is suitable for both males and female, with male pronouns being used for convenience.

It will be appreciated by a person skilled in the art that the present invention is not limited by what has thus far been described. Rather, the scope of the present invention is limited only by the following claims.

1. A wellness apparatus, comprising:
at least one support for a body portion of a user of said apparatus;
at least one robotic actuator adapted to move said body portion; and
a controller configured to control said actuator in accordance with needs of said user for physical exercise, said controller also adapted for assisting said user with primarily non-physical exercise activity.

2. A wellness apparatus according to claim 1, further comprising at least one sensor.

3. A wellness apparatus according to claim 2, wherein said at least one sensor senses a condition of said apparatus.

4. A wellness apparatus according to claim 2, wherein said at least one sensor senses a condition of said user.

5. A wellness apparatus according to claim 1, wherein said body portion of a user is at least a portion of an arm, a leg, a head, a thorax, an upper body or a lower body of said user.

6. A wellness apparatus according to claim 1, wherein said at least one support is adjustable.

7. A wellness apparatus according to claim 1, wherein said at least one support is articulated.

8. A wellness apparatus according to claim 1, further comprising at least one wheel or a track adapted to provide mobility of said apparatus.

9. A wellness apparatus according to claim 1, wherein said non-physical exercise activity includes a cognitive exercise.

10. A wellness apparatus according to claim 1, further comprising at least one stimulator adapted, and constructed to stimulate at least a portion of said user.

11. A wellness apparatus according to claim 1, further comprising a base.

12. A wellness apparatus according to claim 1, wherein a position of said apparatus is variably adjustable over a range between a user-standing position and a user-lying down position, including a user-sitting position.

13. A wellness apparatus according to claim 1, further comprising a receptacle for user generated substances.

14. A wellness apparatus according to claim 4, wherein said physical and non-physical exercise is matched to said sensed condition of said user.

15. A wellness apparatus according to claim 1, wherein said non-physical exercise activity is at least one of socializing, scheduling support, typical daily activities and controlling other devices.

16. A wellness apparatus according to claim 15, wherein said typical daily activities includes at least one of sleeping, eating, assuming various positions exercise or moving around.

17. A wellness apparatus according to claim 15, wherein said scheduling support includes at least one of waking up said user, providing reminders, or providing timely medication.

18. A wellness apparatus according to claim 15, wherein said socializing includes at least one of communicating with others or participating in activities with others.

19. A wellness apparatus according to claim 15, wherein controlling other devices includes controlling at least one of an entertainment device, a household device, a communication device, a door or an alarm.

20. A wellness apparatus according to claim 1, wherein said apparatus is adapted and constructed to accommodate an obese user.

21. A wellness apparatus according to claim 1, wherein said apparatus is linked to a second wellness apparatus operating in parallel.

22. A wellness apparatus according to claim 1, further comprising a communication link between said apparatus and a remote monitoring location.

23. An exercise device, comprising:
a base;
an arcate element rotatably mounted on said base and having a radius of at least 60 cm; and
at least one handle attached to and adapted to move along said arcate element.

24. A method for managing a user of a wellness device, comprising:
sensing by at least said wellness device a condition of said user;
matching automatically an activity of said user to said sensed condition, prior to commencing said activity; and
wherein the activity is performed while using said wellness device.

25-54. (canceled)

55. A method of teaching a wellness apparatus an exercise to be performed on said apparatus, comprising:
situating a user of said apparatus in an exercise position in said apparatus;
performing a series of steps of said exercise on the wellness apparatus;
recording the series of steps for future performance; and,
repeating any steps not properly recorded by said wellness apparatus during said performing.

56. A method according to claim 55, wherein said teaching is conducted from a remote location.

57. A method according to claim 55, wherein said teaching is conducted by a therapist of said user.

58. A method according to claim 55, wherein said teaching is conducted by an assistant of said user.

59. A method according to claim 55, wherein said teaching is conducted by a family member of said user.
